(19) United States
(12) Patent Application Publication
(10) Pub. No.: US 2017/0341323 A1
(43) Pub. Date: Nov. 30, 2017

(54) METHOD FOR INSTALLING A MOUNTING FOR AN ELECTRONIC TIRE MODULE

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: JULIEN DESTRAVES, Clermont-Ferrand (FR); MICHEL ROBERT, Clermont-Ferrand (FR)

(21) Appl. No.: 15/536,215

(22) PCT Filed: Dec. 13, 2015
(86) PCT No.: PCT/IB2015/002329

§ 371 Date: Jun. 15, 2017

(30) Foreign Application Priority Data
Dec. 15, 2014 (FR) 1402853

(51) Int. Cl. B29D 30/00

(52) U.S. Cl. CPC B29D 30/0061; B29D 2030/0072

(57) ABSTRACT

A method is provided for installing a mounting against a wall of a tire. The mounting is formed of an elastomeric material and holds an electronic module. The method includes steps of: providing a mould that includes a mould cavity, placing an unvulcanized mounting in the mould cavity, and vulcanizing the unvulcanized mounting simultaneously with vulcanizing other components of the tire.

### TECHNICAL FIELD OF THE INVENTION

The present invention relates to a method for installing a mounting or patch for an electronic module against a wall of a tire. It also relates to a tire mould specifically designed for the use of this method.

### STATE OF THE PRIOR ART

In general, tires equipped with electronic modules for providing certain functions, such as the monitoring of pressure, temperature and various other data, are known. For the most part, such modules are fastened to the tire by means of a patch placed against a wall of the tire.

Conventionally, this patch is fastened in a stage subsequent to the manufacture of the tire. This operation gives rise to a number of problems.

Some of these problems relate to the method for installing the patch on the tire. A first problem is the period of immobilization of the tire. This is because the surface of the tire wall on which the patch is to be installed must first be prepared, after which the installation is carried out. Finally, the tire must be immobilized for a considerable period, notably in order to ensure that the bonding is effective and durable.

The performance of an installation operation after the moulding of the tire represents a considerable cost, owing to the equipment used and the labour required.

Finally, the fastening of a patch to a tire must be carried out by very precise positioning, notably as regards the azimuth adjustment.

Other difficulties relating to the actual purpose of the tire equipped with such a patch may be observed. For example, the installation of a patch on a tire may reveal a line break or potential defects related to the bonding operation.

Finally, it must be possible to ensure that the bonding is durable, to avoid any risk of possible detachment.

Furthermore, some products used in the installation of the patch on the tire may prove to be harmful to the tire.

The document US2007246151 describes a tire in which an antenna is integrated into the lower area of one of the sidewalls.

The solutions disclosed by the prior art have a number of imperfections, regardless of their arrangements. Consequently there is still a need for an effective solution for controlling different intrinsic functions of the electronic modules of tires, in relation to identification data.

The invention provides various technical means for overcoming these various disadvantages.

### SUMMARY OF THE INVENTION

To begin with, a first object of the invention is to provide a procedure for simplifying the fastening of electronic modules to tires.

Another object is to provide a procedure which can avoid the problems relating to the reference marking and azimuth adjustment for positioning when an electronic module is installed on a tire.

Yet another object is to provide a way of fastening electronic modules to tires which eliminates the risk of detachment.

Yet another object is to provide a way of fastening electronic modules to tires which eliminates the use of solvent on the walls of the tires.

For this purpose, the invention provides a method for installing a mounting of elastomeric material for for an electronic module against a wall of a tire, comprising steps in which:
i) a patch mould cavity is provided in a mould;
ii) an unvulcanized mounting is placed in said mould cavity;
iii) the pre-mounting is vulcanized simultaneously with the other components of the tire.

This method enables tires to be manufactured with integral patches, according to an optimal arrangement. Since the patch is directly formed with the tire, it is no longer necessary to immobilize the latter to perform preparation and installation operations. The retention of the patch is ensured, and the risk of detachment is practically eliminated.

With an electronic module advantageously placed in the mounting before moulding, all the operations relating to the integration of the module into the tire may be performed before the end of the tire manufacturing process, thus avoiding the need to immobilize the tire subsequently.

According to an advantageous embodiment, a counter-shape having a profile corresponding to that of the mounting to be moulded is placed in the mould cavity. This counter-shape is advantageously arranged in a removable manner.

Advantageously, the unvulcanized mounting is shaped directly in the counter-shape.

In a variant, the unvulcanized mounting is partially cured before its insertion into the cavity.

According to an advantageous embodiment, the unvulcanized mounting is pre-formed, by pressing for example, before its insertion into the cavity.

According to another embodiment, the unvulcanized mounting is shaped directly in the counter-shape.

According to yet another advantageous embodiment, the unvulcanized mounting is shaped by the injection of an elastomeric composition.

According to yet another variant, the unvulcanized mounting is shaped by the assembly of partially cured elements, at least one electronic module, and an elastomeric composition.

### DESCRIPTION OF THE FIGURES

All the details of application are given in the following description, supplemented by FIGS. 1 and 2, provided solely by way of non-limiting example, in which:

FIG. 1 is a sectional view of a mould having a counter-shape for moulding a patch simultaneously with the tire for which it is intended; and

FIG. 2 is a sectional view of a variant embodiment of the mould of FIG. 1 for moulding a patch simultaneously with the tire for which it is intended.

### DETAILED DESCRIPTION OF THE INVENTION

In the present document, the expression “unvulcanized mounting” is taken to mean a mounting or patch formed from an elastomeric composition, designed for insertion into a mould cavity specifically arranged in the tire mould. The unvulcanized mounting and/or the mould cavity, or any other intermediate element, are preferably designed with the shapes and sizes which the patch is to have when it is formed.

The principle according to the invention is that of installing the mounting or patch in the tire finishing mould before the tire is vulcanized.

There are two feasible methods, namely methods with and without a removable mould element.

Moulding in a Cavity without a Removable Mould Element

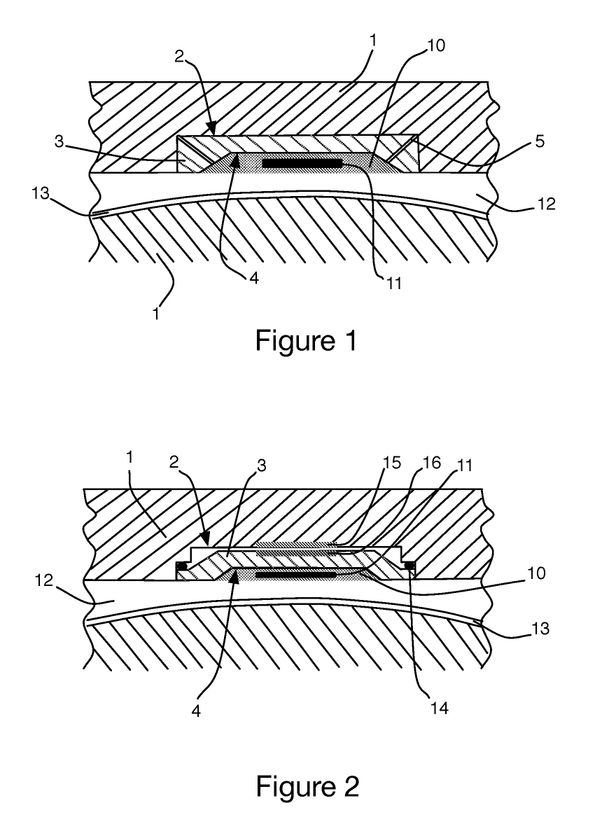

As shown in FIG. 1, a mould 1 according to the invention has a cavity 2 formed in its inner wall. A suitable counter-shape 3 is housed in the cavity 2. An electronic module 11 is placed in the mounting 10, preferably before the tire is moulded and vulcanized. In a preferred embodiment, the counter-shape 3 is applied in the cavity 4. This counter-shape 3 is configured with a profile 4 which corresponds to (or is the reverse of) the profile of the patch 10. One or more vent holes 5 are advantageously provided. In the illustrated example, the vent holes 5 link the mounting 10 to be moulded to the mould 1.

FIG. 1 also shows a portion of tire 12 into which the patch is to be integrated. In a conventional way, the tire is retained, on the side opposite the patch 10, by a membrane 13 and the inner portion of the mould 1.

### Moulding in a Cavity Containing a Removable Mould Element

According to this embodiment, a removable mould element or counter-shape 3 is provided in the cavity 2 of the mould 1. The removable mould element has the advantage of allowing the positioning of the components of the patch 10 outside the tire mould 1, thus facilitating the necessary manipulation.

FIG. 2 shows a variant embodiment in which magnets 15 and 16 are provided between the counter-shape 3 and the mould 1. In the illustrated example, a magnet 16 is arranged at the back of the counter-shape 3, and a second magnet 15, of opposite polarity, is arranged against the corresponding wall of the mould 1. These magnets facilitate the positioning of the counter-shape 3 in the mould 1. In a variant, a single magnet 15 or 16 is provided. Additionally, a sealing gasket 14 seals the free area between the counter-shape 3 and the mould cavity 2.

### Specific Features of the Patch

Regardless of the variant of mould used, the elements used to shape the patch 10 may be pre-formed (by stamping, for example) before they are positioned, or may be formed by the injection of an elastomeric composition.

The shaping may also be carried out by the assembly of partially cured elements, at least one electronic module, and/or an elastomeric composition.

According to the function of the electronic module or modules 11 inserted into the patch 10, the latter, and therefore the impression or cavity 2 in the tire mould 1, may be located in any area of the mould. For example, if the electronic module 11 is designed to carry out a localized measurement function or a function relating to a power generation system, the position is determined on the basis of the physical parameters concerned. By way of example, a patch 10 may be provided in a tread pattern element for the measurement of grip or forces, or at the equator for piezoelectric power generation system.

In the case of a system without a measurement function, such as a stand-alone mounting, or an autonomous function of the RFID data transmission type, the position of the patch 10 is determined with the aim of achieving a satisfactory compromise between the mechanical stresses on the tire during use, on the one hand, and ease of access to the mould, on the other hand.

### REFERENCE NUMERALS EMPLOYED IN THE FIGURES

1 Mould
2 Cavity
3 Counter-shape
4 Moulding profile of the mounting
5 Vent hole
10 Mounting (or “Patch”)
11 Electronic module
12 Tire
13 Membrane
14 Sealing gasket
15 Counter-shape magnet
16 Counter-shape magnet

1-8. (canceled)

9. A method for installing a mounting, which is formed of an elastomeric material and which holds an electronic module, against a wall of a tire, the method comprising steps of:
providing a mould that includes a mould cavity therein;
placing an unvulcanized mounting in the mould cavity;
vulcanizing the unvulcanized mounting simultaneously with vulcanizing other components of the tire.

10. The method according to claim 9, further comprising a step of:
placing in the mould cavity a counter-shape having a profile corresponding to a profile of the unvulcanized mounting.

11. The method according to claim 10, wherein the counter-shape is placed in the mould cavity in a removable manner.

12. The method according to claim 10, wherein the unvulcanized mounting is shaped directly in the counter-shape.

13. The method according to claim 9, wherein the unvulcanized mounting is partially cured before being placed in the mould cavity.

14. The method according to claim 9, wherein the unvulcanized mounting is pre-formed before being placed in the mould cavity.

15. The method according to claim 9, wherein the unvulcanized mounting is shaped by injection of an elastomeric composition.

16. The method according to claim 9, wherein the unvulcanized mounting is formed of:
an assembly of partially cured elements,
at least one electronic module, and
an elastomeric composition.
